(19) United States
(12) Patent Application Publication
(10) Pub. No.: US 2026/0176095 A1
(43) Pub. Date: Jun. 25, 2026

(54) METHOD AND DEVICE FOR PROVIDING STRIP MATERIAL FOR MANUFACTURING COMPONENTS FOR VEHICLES, AS WELL AS CORRESPONDING COMPONENT AND VEHICLE WITH SAME

(71) Applicant: Airbus Operations GmbH, Hamburg (DE)

(72) Inventors: Paul Jörn, Hamburg (DE); Carsten Rowedder, Hamburg (DE); Jesper Buck, Hamburg (DE); Frederick Nabor, Hamburg (DE)

(73) Assignee: Airbus Operations GmbH, Hamburg (DE)

(21) Appl. No.: 19/425,344

(22) Filed: Dec. 18, 2025

(30) Foreign Application Priority Data
Dec. 20, 2024 (DE) 102024139393.9

(51) Int. Cl. B65H 19/18; B64F 5/10

(52) U.S. Cl. CPC B65H 19/18; B64F 5/10; B65H 2301/20; B65H 2701/172

(57) ABSTRACT

A method and a supply device for providing composite strip material, in particular for the manufacture of components for vehicles, such as aircraft, as well as a corresponding component and vehicle, in particular aircraft, wherein a continuous material feed of the strip material for manufacturing the components includes at least two material portions which are supplied in the course of the continuous material feed.

### TECHNICAL FIELD

The present disclosure relates to a method for providing composite strip material for the manufacture of components, in particular for vehicles such as aircraft, a supply device for providing composite strip material, in particular for the manufacture of components for vehicles such as aircraft, a component for a vehicle, in particular an aircraft, and a vehicle, in particular an aircraft.

### BACKGROUND

Components for vehicles, in particular aircraft, and methods for their manufacture are known from the prior art and increasingly contain high proportions of composite materials. In modern commercial aircraft, for example, more than 50% of the primary structural elements are already made of composite materials. The aerospace industry has accelerated the introduction of these materials, significantly reducing the weight of aircraft, which leads to lower fuel consumption and a corresponding reduction in greenhouse gas emissions. This brings both ecological and economic benefits.

WO 2021/018578 A1, for example, relates to a method for manufacturing a component for an aircraft. These are, in particular, components for the frame, such as frames and stringers. Aircraft are increasingly being constructed from polymer fiber composites to reduce weight. Originally, these were fiber composites made of thermosetting polymer and carbon fibers. With the development of high-performance thermoplastics, thermoplastic fiber composites have increasingly become the focus of research and development. One example of such a high-performance plastic is poly(ether ether ketone). However, the manufacture of components from thermoplastic fiber composites is a complex process. The publication describes an improved method for manufacturing such components, which comprises the following steps: manufacturing a flat object from a thermoplastic fiber composite material comprising a thermoplastic polymer material and reinforcing fibers embedded therein, forming the flat object into a semi-finished product, and solidifying the semi-finished product to obtain the component.

EP 3 248 774 B1 discloses a fire-resistant polymer matrix composite structure comprising a layer of carbon fiber reinforced plastics (CFRP) with a first side and a second side and a first GFRP layer located on the first side of the CFRP layer or on the second side of the CFRP layer. The CFRP layer may consist of a carbon fiber tape or a carbon fiber fabric. In addition, the publication discloses an aircraft comprising the fire-resistant polymer matrix composite structure.

EP 2 660 048 B1 relates to a composite material structure comprising a continuous first layer of composite material, a second layer of viscoelastic material, and a continuous third impact protection layer. The first layer is formed by structural components in the form of a matrix and fibers. The second layer of viscoelastic material is applied to the first layer, and the second layer may be continuous or discontinuous. When a discontinuous second layer is used, elongated, circular, or square voids are arranged within the layer. Optionally, reinforcements comprising carbon nanofibers or nanotubes are provided in one of the first and second layers. The third layer of impact protection material is added in a continuous manner to the second layer, with the third layer forming the outermost layer of the composite material. In addition, this third layer is electrically conductive. The composite material has noise damping, impact resistance, and electrical conductivity properties.

EP 2 156 943 A1 proposes a molding process for forming geometrically complex laminates from composite material, which makes it possible to obtain very complex folded geometries, reduce the influence area of the molded areas and make its effect local, handle the geometry of the laminate near the area to be molded, and replace the molded geometries with folded geometries, thereby limiting the influence area of the molding locally so that the length of the reinforcement fibers affected by the molding is minimal.

The increased use of CFRP poses significant challenges for waste disposal. As its use increases, so does the volume of waste. Waste is generated during production from offcuts or residual material at the end of the spool on which the CFRP is supplied as strip material, as well as at the end of the respective product life cycle.

Unlike conventional materials such as aluminum or steel, which can be easily melted down and recycled into new material of comparable quality, CFRP poses a relatively unique challenge. The structure of CFRP contains fibers embedded in a resin matrix, which requires highly specialized, technically complex, and energy-intensive recycling processes. In addition, the resulting recycled products are often of significantly lower quality than the raw material. Conventional cutting methods, in which the material is cut lengthwise into narrower strands, are impractical and financially unfeasible for processing short residual spools.

Vehicle manufacturers'production facilities therefore generate relatively large quantities of high-quality CFRP waste in the form of so-called end-of-spool material, which arises in particular because CFRP is supplied as strip material on spools that are not completely used up in the manufacturing process for the respective components. The resulting residual material is particularly suitable for reuse as it is free of defects and impurities. Using this residual material to manufacture sheet molding compound (SMC) offers an excellent opportunity to reduce waste.

The following steps are required according to the state of the art for processing unhardened CFRP waste into discontinuous fiber-reinforced semi-finished products such as SMC or BMC semi-finished products: (a) Splicing and rewinding: To connect several relatively short ends of CFRP strips (slit) into a long material spool. This is necessary to enable continuous production of homogeneous SMC reuse material. (b) Slitting: The width of the CFRP strip that is processed into reusable SMC is, for example, 12.7 mm. Materials with a different width must therefore be cut to the desired size so that only one chip length is present in the SMC.

With state-of-the-art processes and devices, these steps can in principle only be carried out separately. Each of these steps requires manual handling of the remaining spools. For a 12.7 mm wide slotted strip (406 g/m² fiber matrix) with 20 m remaining on each spool (average 100 g per spool), almost 1000 leftover spools are required for 100 kg of SMC with 1900 g/m² (fiber matrix). Normal SMC machines run at 2 m/min, for example, producing approx. 100 kg after 1 hour, which corresponds to a material throughput of approx. 1.6 kg/min or 16 spools per minute. Even at a lower speed of 0.5 m/min, 4 spools per minute are required. The manual handling and feeding of the material into the various machines therefore requires a great deal of effort and thus potentially incurs prohibitively high costs for the preparation of the material feed in the production (cutting machine) of reusable SMC.

In addition, two major difficulties prevent the provision of reusable SMC material. The first key difficulty is that, at an average feed speed of 0.5 m/s into the SMC machine, continuous processing is not possible due to frequent material changes. For a single batch of 100 kg of SMC material, up to 1,000 residual rolls must be processed, which makes manual handling impractical. The second key difficulty is that, in an effort to increase production efficiency, increasingly wider 2″ strip material 20 is being used for large components. However, conventional SMC production machines can only process strip material with a maximum width of 1.27 cm and are therefore hardly able to process the increasingly wider strip material without waste.

In light of the already very high and likely to increase use of composite materials, especially CFRP, as well as their difficult disposal, the state of the art in the provision and use of composite strip material presents a number of problems. On the one hand, these problems lie in the relatively high and likely to increase costs for scrap that has not yet been economically usable, especially spool end material or residual spools with strip material. On the other hand, problems arise from the costs of disposing of the scrap.

### SUMMARY

It can be considered an object to generally reduce the amount of composite material waste generated during the manufacture of components. In particular, it can be considered an object to use scrap material for the manufacture of components that would otherwise be generated as waste according to the current state of the art. This object is solved by the subject matter herein.

Further embodiments are apparent from the following description. Features described in relation to methods and corresponding method steps can be implemented as device features or vice versa. Sections of the description relating to the method therefore also apply analogously to a supply or manufacturing device and computer programs for controlling it. In particular, method steps and related components mentioned can be implemented as functions of the supply or manufacturing device and corresponding computer programs, and any functions of the manufacturing device can be implemented as method steps.

In particular, the object is solved by a method for providing composite strip material for the manufacture of components, in particular for vehicles such as aircraft, wherein a continuous material feed of the strip material for manufacturing the components comprises at least two material portions which are supplied in the course of the continuous material feed.

In a supply or manufacturing device for providing composite strip material, in particular for the manufacture of components for vehicles, such as aircraft, the object is solved by the device being designed to carry out a corresponding process.

In the case of a component for a vehicle, in particular an aircraft, the object is solved in that the component is manufactured at least in sections using composite strip material supplied according to a corresponding process.

In the case of a vehicle, in particular an aircraft, the object is solved in particular by comprising at least one corresponding component.

For example, a continuous material feed of the strip material for manufacturing the components can be composed of at least two material portions which are joined together during the continuous material feed in the supply device and/or a processing device. Alternatively, or additionally, material portions can be supplied to the processing device with as little overlap and/or gaps as possible. The strip material can be used in the manufacturing device to manufacture components and/or semi-finished products, whereby the semi-finished products can then be further processed into components.

According to the proposed solution, an inline material preparation unit can be provided that enables highly automated processing of strip material, in particular slit tape residual material, on an industrial scale. The solution can be applied to any material or surface shape of components made of composite materials. The strip material provided can be further processed in various machines and technologies for a wide variety of components and any applications from vehicles to sporting goods or similar, e.g., as discontinuous semi-finished products in flat form (e.g., SMC), bulk materials, e.g., BMC, SFI compound, long-fiber thermoplastics, TS/TP matrix, etc.

The proposed solution offers a number of advantages over the prior art. On the one hand, it enables cost-efficient use of material residues while reducing waste in production facilities, which in turn reduces the use of spool bodies and carrier film. On the other hand, the proposed solution saves time and creates more usable working time, whereby a shorter lead time to material production extends the shelf life of the strip material provided and reduces transport and waiting times as well as storage times in a controlled cooled environment. In addition, improved quality control is possible thanks to a closed, controlled environment. Overall, the proposed solution creates potential for significant cost savings through a high degree of automation and a reduction in process steps.

According to one embodiment of a method, it may be provided that the at least two material portions are taken from two different material spools with strip material. In this way, material spools can be used seamlessly one after the other and the strip material contained therein can be provided continuously. For example, spools with suitable residual material can be looped into the material provision process. In this way, strip material can be provided quickly and efficiently while reducing waste.

According to one embodiment of a method, it may be provided that spool bodies of material spools for winding strip material are ejected mechanically after the strip material has been substantially completely removed. In this way, the spools can be inserted and ejected in a magazine-like manner. This further accelerates the efficient provision of the strip material.

According to one embodiment of a method, it may be provided that end sections of two material portions joined together are being spliced. The splicing, i.e., joining together, of the end sections can be performed automatically. In this way, an endless continuous material supply can be provided.

According to one embodiment of a method, it may be provided that adhesive residues are removed from the end sections before splicing. An end section of the strip material is often attached to the spool body with an adhesive. This adhesive can contaminate the strip material during processing. Removing the adhesive ensures that the strip material has the required purity.

According to one embodiment of a method, it may be provided that the strip material is at least temporarily stored in a material buffer device. The material buffer device may, for example, comprise between spools, deflections, and/or deflections for the strip material. By temporarily storing the strip material in the material buffer device, time periods during which the end sections of the strip material are connected to each other and/or spool bodies are ejected or inserted can be overcome in order to ensure a continuous supply of strip material. This further helps to provide an endless continuous material supply efficiently at high speed.

According to one embodiment of a method, it may be provided that the strip material is slit lengthwise in a transfer arrangement before being transferred to a manufacturing device in order to provide the at least two material portions. The method may use different input formats of the strip material, such as with a width of ½ inch, 2 inches, 300 mm, etc. Up to a certain width, such as ½ inch, longitudinal slitting may be omitted. Above a certain width, the strip material may be longitudinally slit or cut as so-called slit tape. The resulting material can be stored on spools again. Advantageously, the material is pushed through cutting blades or a corresponding cutting mechanism for longitudinal slitting, in particular after the material buffer device and before being made available or transferred to the manufacturing device. This enables optimal material utilization as well as continuous and fully automated material feeding or provision.

According to one embodiment of a method, it may be provided that the strip material is continuously fed to a manufacturing device for manufacturing the components or corresponding semi-finished products. Thus, the manufacturing device does not have to be converted to use new material feeds and can therefore be used continuously to manufacture components in accordance with the respective requirements. In this way, the speed and efficiency of component manufacturing can be further improved.

### BRIEF DESCRIPTION OF THE DRAWINGS

Some details are described in more detail below with reference to the accompanying drawings. The illustrations are schematic and not to scale. Identical reference symbols refer to identical or similar elements. They show:

FIG. 1A schematic side view of an example of a vehicle in the form of an aircraft;

FIG. 2 a schematic cross-sectional view of the vehicle shown in FIG. 2 with a series of composite components along a section line A-A shown in FIG. 2;

FIG. 3 a schematic representation of a supply device for the continuous provision of strip material made of composite material together with a processing device for the manufacture of components, which together form a manufacturing system; and

FIG. 4 a schematic representation of steps in a method for manufacturing components using composite strip material.

### DETAILED DESCRIPTION

The following detailed description is merely illustrative and is not intended to limit the disclosure herein and its possible uses. Furthermore, there is no intention to be bound by the above background or the following detailed description. The representations and illustrations in the drawings are schematic and not to scale. Identical elements are generally designated by the same reference numerals. An improved understanding of the subject matter described can be obtained by viewing the illustrations and their detailed description together.

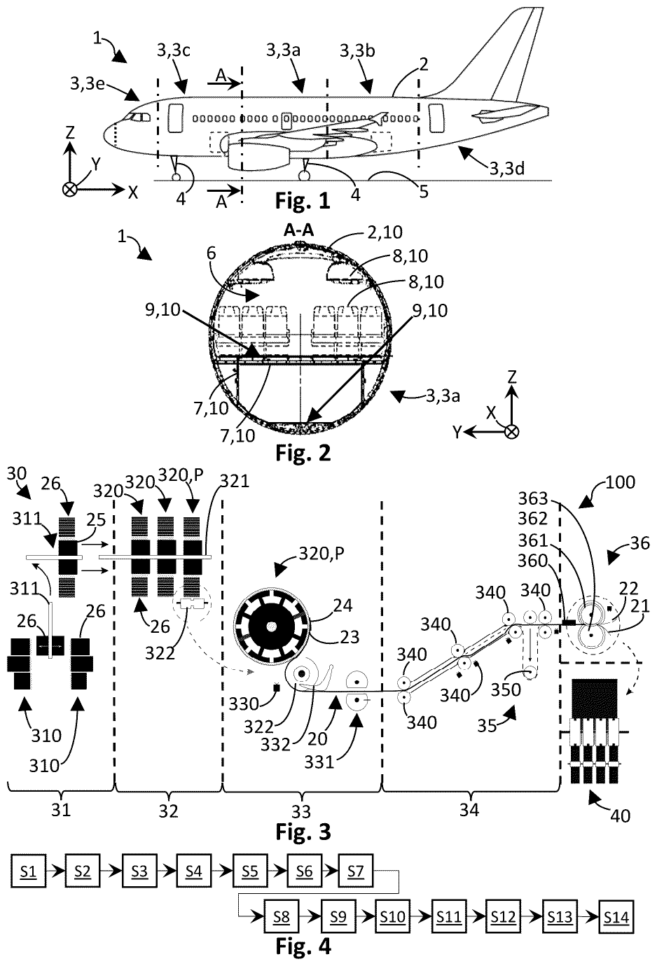

FIG. 1 shows a schematic side view of a vehicle 1 in the form of an aircraft, which comprises a supporting structure 2 in the form of a fuselage with several supporting structure sections 3 that are connected to each other. For example, the support structure sections 3 comprise a first section 3a, a second section 3b, a third section 3c, a fourth section 3d, and/or a fifth section 3e. The first section 3a may be a middle section of the support structure 2. The second section 3b may be a rear section of the support structure 2. The third section 3c may be a front section of the support structure 2. The fourth section 3d may be a rear section of the support structure 2. The fifth section 3e may be a bow section of the support structure 2.

The support structure 2 may rest on a ground 5 by a landing gear 4 and surround an interior space 6 that accommodates a mounting structure 7 attached to the support structure 2 (see FIG. 2). The mounting structure may accommodate fixtures 8, such as paneling, storage containers for luggage, and seats for passengers, and may be at least partially covered by interior structures 9, such as floor panels. The vehicle 1 and thus the above-mentioned components thereof extend in a longitudinal direction X, a transverse direction Y, and a height direction Z, which together form a Cartesian coordinate system.

FIG. 2 shows a schematic cross-sectional view of the vehicle 1 shown in FIG. 1 along the cross-sectional line A-A shown therein. Here it becomes evident that the mounting structure 7 is mounted on the support structure 2. The interior structure 9 rests on the mounting structure 7. The support structure 2, mounting structure 7, fixtures 8, and/or interior structures 9 may consist of and/or comprise components 10 that may be manufactured, at least in sections, from composite tape material 20, such as CFRP (see FIG. 3).

FIG. 3 shows a schematic representation of a supply device 30 for the continuous supply of tape material 20, for example in the form of cutting tape or slit tape made of composite material, which during operation is composed of a first portion of material 21 and at least one second or further portion of material 22. End sections 23 of the tape material 20 can be attached to a spool body 25 with an adhesive 24, onto which the tape material 20 can be wound for simplified handling and thus be available in the form of material spools 26. The supply device 30 comprises a storage arrangement 31, a unwinding device 32, a rewinding device 33, a transport arrangement 34, a material buffer device 35, and a transfer arrangement 36. The supplied tape material 20 can be transferred directly to a processing device 40 for further processing to manufacture the components 10, which together with the supply device 30 can form at least part of a manufacturing system 100 for the components 10.

In the storage arrangement 31, the material spools 26 are preferably stored flat and vertically stacked on stacks 310, with their respective unwinding directions aligned in the same direction. Such an arrangement of the material spools 26 maximizes space utilization, minimizes the risk of spools rolling away, and reduces the potential for contamination. An automatic spool lifting device 311 is designed to remove the material spools 26 from the stacks 310 and transport them to the unwinding device 32.

The spool lifting device 311 may be designed so that it can be inserted into and engage with the spool core 25. For example, the spool lifting device 311 may be connected to a gripper by a spreader roller mechanism. This allows the respective material spool 26 to be lifted, rotated, and positioned for unwinding. The inner spreading mechanism should remain on the spool during the unwinding process to ensure that the spool remains centered throughout the unwinding process. After the spools have been completely unwound and removed from the preparation unit, the inner spreading cores can be reused.

The unwinding device 32 may include a mechanism for positioning the rolls for unwinding may comprise multiple material preparation lines. For example, an SMC production machine may process up to 15 input slit tape strands. Since each 2-inch input spool is divided into four ½-inch strands, at least three preparation units 320 of the unwinding device 32 may be required to meet demand without creating an excess of slitting tape strands. The position arrangement 31 may be designed to supply all available preparation units 320 with material spools 26, thus ensuring continuous operation.

For unwinding, the material spools 26, together with the previously inserted inner spreader cores, can be placed on shafts 321 of the unwinding device 320 and unwound from there with the aid of an automatically driven unwinding roller 322. Each shaft 321 can carry a maximum of three material spools 26, for example, one of which is unwound at a time. The remaining material spools 26 can serve as a material supply or buffer, especially if a large number of rewinding devices are to be supplied with strip material 20 at the same time.

As soon as an active material spool 26 is empty and is disposed of, the next material spool 26 can be automatically pushed into an unwinding position P. A spool sensor 330, for example in the form of an optical concentricity sensor, can be provided in the rewinding device 33 to detect when a material spool 26 is empty. The unwinding sensor 323 can be arranged directly behind the unwinding position P and designed, for example, to detect a color difference between the strip material 20, e.g., black carbon fiber tape, and the spool body 25. The unwinding sensor 330 may be located behind the unwinding position P so that the last winding is detected as soon as possible once it is reached.

As soon as it is determined that the active material spool 26 is almost empty, cutting rollers 331 of the rewind device 33 can be activated. During the regular unwinding process, the strip material 20 does not come into contact with the cutting rollers 331. This minimizes contact points and sources of contamination while reducing the frequency of replacement. The advantage of using rollers over a linear guillotine cutting method is that the unwinding process does not have to be slowed down or stopped.

The cutting rollers 331 preferably rotate at the same speed as the cutting tape. This cleanly separates the cutting tape strand from the last remnant of the unwinding process on the material spool 26. A material spool 26 with less than a remnant of the cutting strip is disposed of by being pushed off the end of the shaft 321. The inner spreader core is removed and is ready for reuse, and the inner spool body 25, usually a cardboard spool core, can be disposed of.

The next material spool 26 can then be pushed into the unwinding position P, where the preferably heated unwinding roller 322 is pressed against the surface of the web material 20 in order to find the end section 23 of the web material 20 forming an initial end of the respective further material portion 22. The unwinding roller 322 grips the end of the strip material 20 by utilizing the surface adhesion of the material, which is increased by the heat of the roller. Adhesive 24 contained in the end section, such as adhesive tape, can be prevented from sticking to the unwinding roller 322 by a guide finger 332. The adhesive tape can be pushed toward the next set of unheated driven rollers (not shown) by a profile.

Vacuum suction may be used to remove a carrier film that prevents the turns of the strip material 20 from sticking to each other. The carrier film is separated from the strip material 20 and connected to a rotating spool that pulls the carrier film away from the strip material 20 during the laying process. This manual intervention is not suitable for the material preparation process due to the high throughput of spools. Therefore, the carrier film is being sucked off the cut tape using compressed air. The carrier film is blown through a profile into a central waste container. This approach eliminates the need for manual intervention, thereby optimizing the process. The process is automatically monitored using sensors to confirm that the carrier film has been removed correctly. This error detection process is highlighted in the final process phase.

Once the strip material 20 has been pressed through the heated initial roller into the first set of driven rollers, this roller is disengaged to minimize the accumulation of resin on the surface. Drive rollers of the transport assembly 34 continuously pull the web material 20 off the spool. The material continues to be pressed through the profiles to the next set of driven rollers. This forward and unwinding process is used throughout the material preparation unit, including for each individual material portion 21, 22 of the strip material 20 after cutting.

In order to minimize the gaps between the end sections 23 of the strip material 20 of different spools, the material buffer device 35 is used, for example in the form of a mechanical dancer arm 350. Once the strip material 20 has passed the driven roller sets on both sides of the dancer arm 350, the process of building up a material buffer can begin. The dancer arm 350 lowers, slightly increasing the unwinding speed. This is done so that the strip material 20 transported into the cutting unit with the cutting rollers 331 is not slowed down. When the active spool is empty and is disposed of, the material in the buffer is used up while a new spool is being prepared. This process prevents gaps or overlaps between the material portions 21, 22, for example in the form of cutting tape strands, which could lead to jams or material errors.

As with printing machines, incorrect alignment of the input material can lead to jams or, in the case of cutting, to varying strand widths. To mitigate this problem, a guide 360 of the transfer arrangement 36 with a fixed width, for example in the form of a non-stick coated U-profile, can be mounted behind a set of drive rollers 340 directly in front of cutting blades 361 or a cutting unit of the transfer arrangement 36. Slippage during cutting can occur for various reasons, e.g., due to insufficient material tension or incorrect alignment. Slippage is reduced by mounting flexible rollers 362 on the same shaft as the cutting blades 361.

The flexible rollers 362 have a larger diameter than the cutting blades of the cutting blades 361 so that the rollers can grip the strip material 20 before it is pressed through the cutting blades. Another advantage is that the material is less likely to accumulate in front of the blades because the rollers grip the strip material 20 more effectively than thin blades. Cutting is completed with the cutting blades 361, which are designed, for example, as circular cutting wheels that can run through a grooved support wheel 363. The grooves are wide enough for the blades to fit through without significant friction. The cutting depth of the blades in the grooves ensures that the material is not left uncut.

In the present example, the material portions 21, 22 are thus separated as strands of the strip material 20 by individual guides that can run on the cutting heads. As with the first heated unwinding roller 322 described above, each friction roller may have a groove in which the finger guide runs. This ensures that the strands do not come into contact after cutting and thus cause blockages. Once the four strands, for example, have been separated from each other, they are individually forwarded to the inlet of the processing device 40, for example an SMC production machine, and thus transferred to it. A principle with stepped driven rollers can be used for this purpose.

If failures occur, it is important that they are detected quickly so that the web material 20 is not affected. As soon as failures are detected, warning messages must be issued so that the operators can assess whether the manufacturing system 100 needs to be stopped. Monitoring sensors 341, such as similar sensors implemented for detecting the end of the spool, may be installed throughout the transport arrangement 34 and the transfer arrangement 36. The data collected by the sensors from each set of driven rollers can be used to determine the length of material already present in the unit. This data can be combined with the sensor values along the entire material path to determine whether excess material has accumulated or whether slippage has occurred due to excessive friction.

The status of the strip material 20 should be checked before and after each process task in order to detect errors as quickly as possible. If errors occur, operators are notified immediately. However, the supply device 30 should also be able to correct errors automatically. This is done, for example, by cutting the material already in the unit from the spool using the cutting rollers. These can be rotated to function similarly to a switch. The strip material 20 can be slowly pulled out of the supply device 30 by all driven rollers and discharged into a separate waste container below the cutting unit. This allows operators to monitor the error correction process without having to shut down the entire production line, as would be necessary with manual intervention.

The concept described here as an example aims to fully automate the process of preparing and unwinding strip material 20 for SMC production. The spools can be stored and handled efficiently using an expanding lifting device, which keeps them aligned during unwinding. A series of automated mechanisms, including optical sensors, cutting rollers, and vacuum suction cups, ensure continuous autonomous handling. The strip material 20 is cut securely into strands and forwarded seamlessly to the production machine. Failure handling is optimized through real-time monitoring and automated correction procedures to maximize production continuity.

FIG. 4 shows a schematic representation of steps S or phases of a process for manufacturing components 10 with composite strip material 20. The steps S represent a structure for achieving respective objectives within the process boundaries. For example, each step may be divided into several sub-steps or tasks, each of which may describe a respective working principle. The steps or tasks may also be performed separately from each other in correspondingly separate facilities and arrangements of the supply device 30.

The material supply process begins in a first step S1 with the storage of the material spools 26. Remaining rolls of slit tape should be stored in such a way that they can be removed efficiently. Due to the high throughput of spools and the large number of spools required for the production of a batch of reusable SMCs, the storage area must be optimized for optimal use of space. The climate must be controlled and monitored within the working limits specified for the material.

A second step S2, may involve the provision of spools or the management and preparation of end-of-spool strip material 20 remnants for further use in the SMC production process. The input for this phase is the collected residual spools from the production plant, as described in the first process boundary. The spool provision phase includes all tasks related to the movement of the material while it is still wound on the inner cardboard spool core. In this phase, the spools should be organized for easy removal, but the cut tape should also be detected and cut off before the spool is completely unwound. Completely unwinding the cut tape from the spool can cause the plastic tape connecting the cut tape to the inner core to contaminate the SMC material. The desired result is that new spools are provided and ready for unwinding as soon as the previous spool is completely unwound and the inner core is securely separated from the slotted tape.

In a third step S3, feeding or spool movement can take place, for example by bringing spools with remnants of strip material 20 from the storage arrangement or a corresponding storage area to the unwinding device 31. This ensures an uninterrupted supply of spools that can be unwound in the next production step. The spools must be moved using a reliable system that ensures that no damage occurs due to errors such as collisions or contact with contaminants. The movement system must be able to handle the high volume effectively.

In a fourth step S4, the respective end section 23 must be detected. The strip material 20 is attached to the inner spool core with a plastic tape, for example. If it is not detected that a spool has been unwound to the last turn, material contamination may occur because plastic tape is processed into the SMC material. Such contamination would render the entire batch of SMC material unsuitable for the manufacture of aircraft components. Sensors must detect when a spool is almost empty in order to separate the strip material 20 from the inner core at the right time. The signal to cut the strip material 20 should be given early enough so that there is no risk of contamination, but also as late as possible so that the highest possible percentage of the material on the spool can be used.

In a fifth step S5, the strip material 20 must be separated from the spool body 25. To achieve this, the strip material 20 can be cut off from the inner core of the spool to avoid contamination. The cut must be precise and even to ensure that the strip material 20 is not damaged or frayed, even after many cuts. The cutting process should be strictly controlled, as incomplete separation of the strip material 20 from the spool body 25 can lead to contamination, blockages, and delays in the SMC production process. After cutting, the separated inner spool cores are moved away from the unwinding station and prepared for recycling to make room for the next spool to be unwound.

In a sixth step S6, the respective material spool 26 can be prepared. During spool preparation, fully wound residual spools can be prepared for unwinding, cutting, and further processing. The input of this step preferably consists of a continuous stream of residual spools that have been removed from storage, with the strip material 20 still tightly wound around the inner spool body and covered with the protective carrier film. The spools may arrive in a condition where the end of the strip material must be identified. If necessary, a protective carrier film must also be removed to expose the carbon fiber strip material 20 and prevent contamination in the final SMC material. The material leaving this process stage should be in the form of unwound, exposed strip material 20. The strip material 20 can be gripped securely and positioned to ensure uniform and reliable feeding into the subsequent processing stages.

In a seventh step S7, the respective end section 23 of the strip material 20 can be gripped. To achieve this, the end section 23 must be located. The correct alignment of the strip material 20 is crucial for uniform further unwinding and feeding. Once the end of the strip material 20 has been found and positioned at a predefined location, the material can be completely unwound. Finding the end and simultaneously preventing misalignment or slippage can take varying amounts of time, depending on how much material is left on the spool or where the end is located relative to the machine. Therefore, the initial gripping process is separate from the complete unwinding process, which requires constant speeds and a continuous flow of material.

### Removal of the Carrier Film

In an eighth step, the strip material can be forwarded. Forwarding ensures that the previously prepared strip material 20 is unwound and fed to the subsequent cutting tool efficiently and without interruptions. The input for this stage is the fully prepared strip material 20, which has been correctly positioned and is continuously freed from its carrier film. The focus of the forwarding stage is on creating a continuous and controlled material flow.

Gaps can occur between the end sections 23, as a certain amount of time may elapse before the next material end is found on the following spool. If these gaps in the material flow are not minimized or eliminated, this will result in a varying basis weight in the final SMC material. The desired result of this phase is an uninterrupted stream of strip material 20 that is forwarded to the cutting unit at the defined speed and tension required to maintain optimal production conditions.

In a ninth step, the web material 20 can be unwound. The task of unwinding the web material 20 remaining on the residual spools has a major influence on the consistency of the material feed that is forwarded for cutting. Therefore, the unwinding mechanism must maintain a uniform and controlled speed. While slight variations in unwinding speed are possible to reduce gaps in the material, sudden slowdowns or accelerations can lead to material defects and disrupt the entire process. Unwinding may also include pushing a respective starting piece of the web material 20 into the designated path to the cutting tool, while minimizing residue on the contact surfaces. The unwinding process should be dynamically adjustable to the remaining material quantities and the status of the cutting tool.

In a tenth step S10, gaps are minimized. This task involves managing the gaps that can occur during the transition between the spools. Fluctuations in the feed speed during cutting affect the required cutting force and the resulting quality. Therefore, the feed rate during cutting should remain constant and the gaps between the ends of the cutting strip must be minimized before the material enters the cutting tool. Neither large gaps nor overlaps should be present in the material flow when it enters the cutting and SMC process. Speed variations when unwinding the material from its spool could, for example, be used to build up a buffer that bridges the gap between the ends.

In an eleventh step S11, the strip material can be cut or slit. In this phase, for example, continuously fed 2-inch slit tape can be cut into four strands of ½-inch slit tape, as required for SMC production. The input for this phase is the nearly uninterrupted and correctly tensioned slitting tape stream forwarded from the previous phase. The exact material width of the SMC chips is less important than the tolerances required for processes such as AFP, from which the 2-inch material originates. Therefore, the cutting principle applied may have larger tolerances if this leads to improvements in terms of cost or ease of automation. The cutting process should not compromise the quality of the strip material 20 by fraying or partial cutting. For example, four slit tape strands are output, which should be cut and separated from each other in accordance with SMC requirements. After this phase, the slit tape strands can be fed into or introduced to processing device 40, such as an SMC production machine.

Cutting is the central task of the material preparation unit. The cutting process must be carefully controlled to ensure uniform strand dimensions and to prevent fraying or damage to the cutting tapes. This process step is based on a cutting method that is suitable for material that is pressed into the blades, rather than the conventional approach of pulling the material through. Cutting parameters such as pressure, blade angle, and depth must be optimized not only to meet cutting speed requirements but also to minimize blade wear over time. However, it may also be necessary to adjust these parameters dynamically during the cutting process. For example, the first cut may require higher pressure or a different blade angle to penetrate the slit tape cleanly and establish the correct cutting path. Once continuous cutting is achieved, parameters can be selected to reduce the load on the cutting mechanism and extend the life of the blade. An adaptive approach to cutting parameters should prevent quality degradation and minimize the frequency of blade changes.

In a twelfth step S12, the material should be steadily aligned. Proper material alignment prior to cutting ensures that the cut tape is correctly positioned before it enters the cutting mechanism. This task is critical for maintaining uniform strand widths and avoiding misalignments. Deviations in alignment during cutting result in more carbon fibers having to be cut directly instead of separating cleanly from each other. This would reduce the quality of the strands and lead to significantly higher wear on the cutting mechanism.

In a thirteenth step S13, slippage of the strip material 20 should be reduced. This reduces slippage before and during cutting. Depending on the cutting method selected, the material may accumulate in front of the blades without being pushed through, resulting in a jam. Similarly, slippage during the initial cutting phases can prevent the material strands from reaching the SMC production machine. In addition, maintaining tension and minimizing slippage ensures a clean and precise cutting result. This task reduces the risk of material defects caused by uneven pressure or displacement, thus contributing to the overall process stability of the cutting operation.

In a fourteenth step S14, the material portions 21, 22 can be separated, i.e., strand separation can be performed. Improper separation of the strands after cutting can lead to blockages, as individual strands may not follow their predefined path. To avoid such errors, newly cut strands must be guided into the lanes designated for further processing in the SMC production line. This task ensures that each strand remains untangled and does not overlap or twist with other strands. Proper separation of the strands is crucial for maintaining material flow and ensuring the integrity of the material as it moves on to the next stages of the SMC production process.

The method described in the example can be used to effectively minimize gaps between slit tape strands during an SMC material preparation process. The less the material flow is interrupted, the more uniform the SMC material produced will be. Gaps in the material flow can occur at spool transitions when the previous slit tape spool is empty and the subsequent slit tape spool is still in the process of being prepared. Interruptions in the incoming material flow can immediately lead to variations in the basis weight of the final SMC material. Further consequences of an interrupted input material flow can be uneven layer formation or voids in the composite material. Such defects could potentially render an entire batch of material unsuitable for use in primary structures.

The multiple pre-fill and unwinding capacity proposed herein allows for independent material flows that are completely pre-filled and ready for cutting. When one slitting tape spool is empty, the second slitting tape spool can take over seamlessly. While the second spool is being unwound, a new spool can be inserted into the first unwinding station. The end of the new first spool is found and an initial length of strip material 20 is unwound. As soon as the second spool is empty, the first spool is ready to feed material again. A solution with multiple, for example double, capacity ensures that the SMC production machine can be operated continuously without the risk of material errors.

The solution can adjust the speed of the SMC production machine to the availability of slit tape material during the spool change. When a spool is almost empty, the machine is slowed down so that the empty spool can be replaced. Once the new spool is in place, the slit tape is prepared and fed into the system. Once the gap between the slitting tape strands is closed, normal operating speed is resumed. If the spool change is delayed and insufficient material is detected, production is halted until the new material is fully prepared.

The dancer arm solution can be used as a mechanical material buffer device 35 to eliminate gaps during spool transitions. As the material is unwound, the dancer arm intervenes to create a material buffer. During the intervention process, the SMC production machine continues to be fed at a steady speed, and the spool is unwound slightly faster to account for the material stored in the buffer. Once the first spool is empty, the SMC production machine continues to draw material from the buffer while a new spool is being prepared. Once the buffer is empty and the new spool is ready, the dancer arm returns to its starting position, from which the cycle described is repeated.

The proposed solution allows material preparation steps for providing web material 20 to be optimized. 1. Wide material>end width: A “one-shot” preparation unit can be provided upstream of SMC processing. Fully automated handling and registration of material for quality control and documentation is enabled.

In addition, it should be noted that “comprehensive” or “having” does not exclude other elements or steps, and “one” or “a” does not exclude a plurality. It should also be noted that features or steps described with reference to one of the above embodiments may also be used in combination with other features or steps of other embodiments described above. Reference signs in the claims are not to be considered as limitations.

### Reference Sign List

1 Vehicle/Aircraft/Aircraft
2 Supporting structure
3 Supporting structure section
4 Landing gear
5 Ground
6 Interior
7 Mounting structure
8 Fittings
9 Internal structure
10 Component
20 Strip material
21 First portion of material
22 Further portion of material
23 End section
24 Adhesive
25 spool body
26 Material spool
30 Supply device
31 Storage arrangement
32 Unwinding device
33 Rewinding device
34 Transport arrangement
35 Material buffer device
36 Transfer arrangement
40 Processing device
100 Manufacturing system
310 Stack
311 Spool lifting device
320 Preparation unit
321 Shaft
322 Unwinding roller
330 Unwinding sensor
331 Cutting rollers
332 Guide finger
340 Drive roller
341 Monitoring sensor
350 Dancer arm
360 Guide
361 Cutting blade/cutting mechanism
362 Flexible roller
363 Support wheel
P Unwinding position
S Step
X Longitudinal direction
Y Cross direction
Z Height direction
S1 Storage
S2 Provision
S3 Feeding
S4 End detection
S5 Separation
S6 Prepare
S7 Gripping
S8 Forwarding
S9 Unwind
S10 Minimize gaps
S11 Cutting
S12 Align
S13 Eliminate slip
S14 Cut open

1. A method for providing strip material made of composite material for manufacture of components or vehicles or aircraft, wherein a continuous material feed of the strip material comprises at least two material portions which are provided with the continuous material feed.

2. The method according to claim 1, wherein the at least two material portions are taken from two different material spools with strip material.

3. The method according to claim 2, wherein spool bodies of material spools for winding strip material are ejected mechanically after the strip material has been substantially completely removed.

4. The method according to claim 1, wherein end sections of two material portions joined together are spliced.

5. The method according to claim 4, wherein the end sections are freed from adhesive residues before splicing.

6. The method according to claim 1, wherein the strip material is at least temporarily stored in a material buffer device.

7. The method according to claim 4, wherein the strip material is slit lengthwise in a transfer arrangement before being transferred to a manufacturing device in order to provide the two material portions.

8. The method according to claim 1, wherein the strip material is continuously fed to a manufacturing device for manufacturing the components or vehicles or aircraft.

9. A supply device for providing strip material made of composite material for manufacture of components for vehicles or aircraft, wherein the supply device is configured to carry out the method according to claim 1.

10. A component for a vehicle or an aircraft, wherein the component is manufactured at least in sections using composite strip material provided according to the method according to claim 1.

11. A vehicle or aircraft, comprising at least one component according to claim 10.
